(19) United States
(12) Patent Application Publication
(10) Pub. No.: US 2002/0123703 A1
(43) Pub. Date: Sep. 5, 2002

(54) Vibratory apparatus for distribution of a coating material

(76) Inventor: Phillip Mark, Orlando, FL (US)

Correspondence Address: Eric P. Schellin, 2121 Crystal Drive, Suite 703, Arlington, VA, 22202, US

(21) Appl. No.: 10/101,732

(22) Filed: Mar. 21, 2002

Related U.S. Application Data
(63) Continuation-in-part of application No. 09/711,305, filed on Nov. 14, 2000.

(51) Int. Cl. A61H 1/00

(52) U.S. Cl. 601/46

(57) ABSTRACT

A hand held vibrating instrument in the shape of a conventional pen or pencil writing instrument. The tip of this instrument is to be operationally connected to a tool such as a resilient rod. The instrument is connected to a source of electric power which operates an electric motor. An eccentric weight is secured to a drive shaft of the motor to thereby impart rapid vibrations to the tip of the instrument.

### RELATED APPLICATION

This is a continuation-in-part application of Ser. No. 09/711,305 filed Nov. 14, 2000 of Phillip Mark.

### BACKGROUND OF THE INVENTION

1. Field of the Invention

The field of this invention relates to a hand held instrument which is in the shape of a conventional writing instrument such as a pen or pencil, the instrument has a tip in the shape of a tool such as a resilient rod, but may have a number of configurations such as a rounded or sharp point or may end in a spatula or a series of fingers.

2. Description of the Prior Art

The subject matter of this invention has been found to be of particular utility in the dental field particularly in the manufacture of dental crowns and fixed bridges. However, it is deemed to be within the scope of this invention that the instrument of the present invention could be utilized in numerous other fields. The instrument of the present invention is described in the configuration of a resilient solid appendage. The appendage may take various forms.

In the manufacture of dental devices, there is frequently a need to apply a layer of porcelain composition, for instance, which is applied as a liquid slurry and is then permitted to dry. The dried dental composition is then baked into a solid hard resultant. It is very important that the application be smooth, precise, of constant thickness and to be attractive in appearance and not have a convoluted surface but rather present a smooth appearance. It is common that, in order to achieve such a smooth, consistent and attractive application, there is employed a small brush. It has further been thought that if such a small brush could be vibrated then the application of the slurry composition could be enhanced. Such an arrangement has been disclosed in U.S. Pat. No. 5,247,218 to Sven which is incorporated herein in its entirety by reference.

The prior art type of vibrating brush is connected to a source of electrical power. The Sven device avoids an electrical wire teether arrangement as such significantly affects the mobility of the brush, especially, in a tight cornered situation where one is trying to apply an even smooth coating material. The Seven brush by being battery powered avoids the need for teethering by an electric wire. While the Sven contribution is useful it does not go far enough in that the bristles of a brush by being very thin is not subject to the degree of vibration required to provide a strong smoothing effect.

If a vibrating instrument without the necessity of bristles but provided with a resilient appendage could be constructed that would not have an electrical conducting wire and such an instrument still had the basic overall configuration of a conventional hand held writing instrument such as a pen or pencil, then, the usage of such an instrument would be enhanced especially in right situations. Within the dental field, such an instrument would result in creating a most attractive dental product at a relatively low cost.

### SUMMARY OF THE INVENTION

The structure of the present invention comprises a hand held type of instrument that has an elongated, thin housing which terminates in a tool type appendage such as a small resilient rod. Included within the housing is a relatively small electric motor which when activated will cause the resilient rod to rapidly vibrate. Included within the housing is a deflectable pressure disc wherein this deflectable disc is located in the area where the user's fingers would be normally located when using the instrument. The disc operates a conventional reciproable electric on-off switch. By applying a slight pressure onto the disc will result in turning on the electric motor resulting in vibration of the resilient appendage. Within the back end of the housing is an electrical connection which is to permit the instrument in one embodiment to be mounted within a conventional recharging stand for recharging of the rechargeable battery.

An important objective of the present invention is to construct a vibrating instrument where the instrument does not require any type of connection to an electric wire when it is being employed, therefore being cordless.

Another objective of the present invention is to construct a vibrating instrument which is relatively small in diameter resembling in configuration a conventional writing instrument.

Another objective of the present invention is to construct a hand held vibrating instrument where the vibration of the instrument can be quickly and easily activated and deactivated without requiring changing of the position of the user's hands on the instrument and which does not not require a foot pedal for activation.

### BRIEF DESCRIPTON OF THE DRAWINGS

FIG. 1 is a linear side view of the instrument of the present invention.

FIG. 2 is a longitudinal cross-section of the instrument as depicted in FIG. 1.

FIG. 3 is an enlarged fragmentary longitudinal cross-section of the instrument.

FIG. 4 is an enlarged fragmentary longitudinal cross-section of the instrument while in the vibrating mode.

FIG. 5 is a cross-section taken along lines 5-5 of FIG. 3.

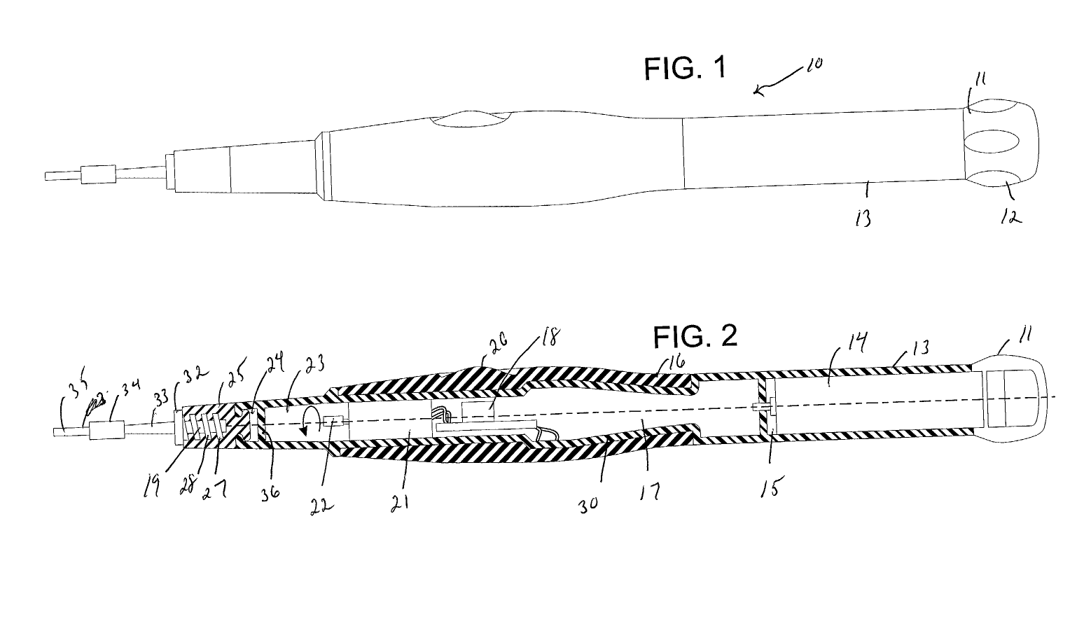

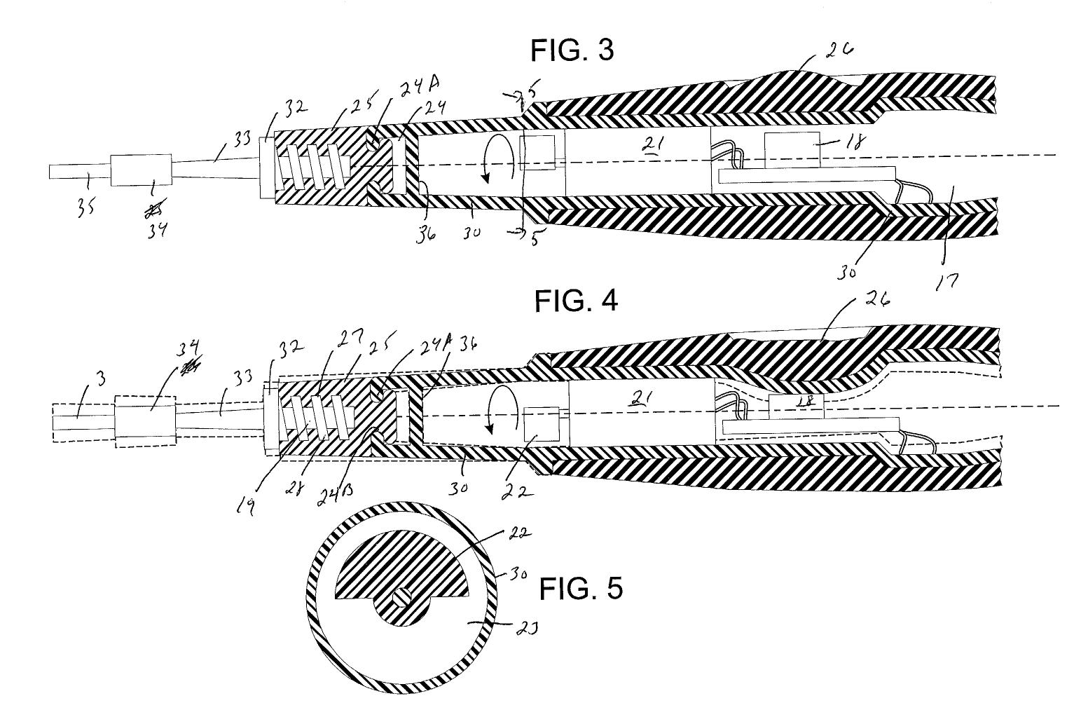

### DETAILED DESCRIPTION OF THE SHOWN EMDODIMENT

Referring to the drawings of the figures, the inventive instrument 10 is shown, generally. It has an elongated tubular shape. In one embodiment the proximate end include a removeable screw on cap 11 which is knurled to provide finger grips 12. Forward of the cap is a tubular chamber 13 which has an AAA battery 14 electrically mounted therein in a conventional manner in compartment 15. Distally of the battery 14 is a tubular handle sleeve 16. The tubular handle sleeve 16 is concentric with chamber 17 which contains in seriatum a micro-switch 18, a small electric motor 21, a rotatable eccentric rotary weight 22, a forward chamber 23 terminating in a distal socket 24 into which is removably affixed to a tool holder 25. The tool holder 25 has a distally extending female threaded socket 27 into which a tool 19 having a male threaded portion 28 is threadingly engaged.

The socket 24 terminates with a distally facing opening which has a radially inwardly extending annular flange 24A. The tool holder 25 has an annular groove 24B adapted and constructed to accept and be secured thereinto the said annular flange 24A.

The sleeve 16 is relatively flexible and the walls 30 of the chamber 17 are concentric therewith. The chamber 17 is also somewhat flexible or resilient.

A disc 26 overlies an area of the chamber 17 which is directly in abutment with the micro-switch 21. By design, a finger manually pressed radially downwardly will operate the micro-switch 21 into one of its two modes, i.e. on or off its two modes, i.e. on or off to provide power to the electric motor or disengage power.

FIG. 5 shows a cross-sectional view of the eccentric rotary weight 22 which, when it is rotated, rotates eccentrically in chamber 23 so that it vibrates to the extent shown in dotted lines in FIG. 4. In vibration of chamber 23 which is constructed of a plastic material in turn vibrate the socket and hence the tool holder 25 and tool 19.

In the configuration shown the tool 19 comprises an elongated abutment or multi-flanged means 31 which has a depth controlling annular flange 32 which has a distal rod portion 33. The rod portion 33 terminates in a wider cylindrical portion 34. The cylindrical portion provides a convenient gripping means for threading the tool 19 into the tool holder 25. In turn, the wider cylindrical portion 34 has a distal rod 35. It is the terminating end distal rod 35 that is used to make contact with the slurry or fluid that is to be smoothed and spread. It will be quickly observed that the direct contact with the vibrations occurring in the chamber 23 transmits the vibrations to the tool and therefore distal rod 35 in a much better fashion and manner than a tuft of bristles which by their very nature accomplish a dampening effect so lack sufficient vibratory action to achieve the desired results of adequately spreading the slurry liquid.

The tool 19 by being easily replaceable makes it possible to use it once and then to dispose the tool 19 at the conclusion of the distribution.

In reiteration, the micro-switch 18 is entirely isolated from the outside so is impervious of contamination. The tubular handle portion 16 in the form of a sleeve is of an elastomeric plastic material. The tubular chamber 17 internally of the tubular portion 16 is also of an elastomeric material so is also flexible. As stated the disc 26 acts as area of contact for the micro-switch 18.

Chamber 23 is isolated from forwardedly extending socket 24 by wall 36. Multi-flanged means 31 has a plurality of spaced radially extending annular flanges 36.

The present embodiment calls for a non-rechargeable battery. As in the Sven patent described in the above the battery may be re-chargeable and a recharging stand may be provided therefor in the same manner (not shown).

A preferred embodiment of the present invention has been described herein. It is to be understood, of course, that changes and modifications may be made in said embodiment without departing from the scope of the present invention, as defined by the appended claims.

What is claimed is:

1. A hand held vibrating instrument comprising an elongated tubular housing for grasping to be used manually similar to a conventional pen or pencil writing instrument, comprising:
said elongated housing having an elongated internal chamber having a proximate end and a distal end;
connecting means mounted on said distal end for connecting a tool;
said connecting means comprising a tool holder, said housing terminates distally in a socket, said socket having distally facing opening which has a radially inwardly extending annular flange, said tool holder has an annular groove adapted and constructed to accept and retain thereinto the annular flange of said socket;
motor means for rotating said tool, said motor means being mounted within said internal chamber, said motor means including a rotatable shaft, a weight eccentrically mounted on said shaft, the rotation of said shaft rotates said weight and produces a rapid vibration at said distal end;
battery means mounted within said internal chamber, said battery means for providing electrical energy to operate said motor means;
switch means for controlling operation of said motor means, said switch means being mounted in said housing;
a disc means, said disc means mounted on said housing, and being integral therewith, said disc means being reciprocable radially and being movable radially between a position to operate said switch means into an activating position and into a deactivating position, said disc being manually pressable to move the switch means to said activating position.

2. The hand held vibrating instrument as defined in claim 1 wherein said tool is constructed of a resilient plastic material and has a rod configuration.

3. The hand held vibrating instrument as defined in claim 1 wherein the tool has a rod configuration with proximate and distal end portions the proximate end portion has a radially extending flange adapted and constructed to abut against said tool holder.

4. The hand held vibrating instrument as defined in claim 3 wherein the tool has a radially larger cylindrical portion intermediate said distal and proximate end portions.

5. The hand held vibrating instrument as defined in claim 1 wherein the tool holder as a female threaded engaging means and said tool has a male threading engaging means adapted and constructed whereby the tool means may be screwed into said tool holder.
